(19) United States
(12) Patent Application Publication
(10) Pub. No.: US 2015/0325111 A1
(43) Pub. Date: Nov. 12, 2015

(54) ELECTRONIC APPARATUS AND ELECTRONIC APPARATUS CONTROL SYSTEM

(71) Applicants: Kabushiki Kaisha Toshiba, Tokyo (JP); Toshiba Lifestyle Products & Services Corporation, Tokyo (JP)

(72) Inventor: Chikara Ushimaru, Akishima Tokyo (JP)

(21) Appl. No.: 14/621,755

(22) Filed: Feb. 13, 2015

Related U.S. Application Data
(63) Continuation of application No. PCT/JP2014/062614, filed on May 12, 2014.

(51) Int. Cl. G08C 17/02

(52) U.S. Cl. CPC G08C 17/02; G08C 2201/30

(57) ABSTRACT

According to one embodiment, a button data notification unit transmits button data of a plurality of operation buttons for operating an electronic apparatus to a server. The operation button notification unit transmits a control command to the server in response to an operation of an arbitrary operation button. An instruction command receiver receives an instruction command related to an operation button to be displayed and an operation guide corresponding to the operation button in accordance with the control command. The server prepares the instruction command based on various cases. An operation guide output unit outputs, to a display device, the operation button and the operation guide to be displayed in accordance with the received instruction command.

### CROSS REFERENCE TO RELATED APPLICATIONS

This application is a Continuation application of PCT Application No. PCT/JP2014/062614, filed May 12, 2014, the entire contents of which are incorporated herein by reference.

### FIELD

Embodiments described herein relate generally to an electronic apparatus and an electronic apparatus control system.

### BACKGROUND

Electronic devices such as a television receiver and a data recording/reproducing device comprise a remote controller as an accessory component. In the remote controller, many operation buttons are arranged. When the user selects and presses an operation button of the remote controller, the operation result of the button is reflected on the electronic device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows a typical example of a structure of an electronic apparatus control system to which an embodiment is applied.

FIG. 2 shows a typical example of a button data table transmitted from a client device to a server according to an embodiment.

FIG. 3 shows the external appearance of a remote controller used in an embodiment.

FIG. 4 shows a typical example in which an operation guide sent from a server to a client device is displayed according to an embodiment.

FIG. 5 shows another typical example in which an operation guide sent from a server to a client device is displayed according to an embodiment.

FIG. 6 shows another typical example in which an operation guide sent from a server to a client device is displayed according to an embodiment.

FIG. 7 shows a typical example of a configuration of a television receiver to which an embodiment is applied.

FIG. 8 shows a typical example of a configuration of a controller of the television receiver shown in FIG. 7.

FIG. 9 shows a typical example of a configuration of a server related to this embodiment.

### DETAILED DESCRIPTION

Various embodiments will be described hereinafter with reference to the accompanying drawings.

In the recent electronic devices, many functions have been added, and operations range widely. Because of this, many operation buttons have been added to remote controllers.

The operation guide may be indicated by the shape of the operation button. For example, a triangle operation button indicates the control direction of move of the cursor or indicates the direction of increase or decrease in sound volume. In an operation for a video reproducing device, a triangle operation button indicates the fast-forward or backward direction.

On some operation buttons, characters or figures are imprinted. For example, a number or the legend “channels”, “sound volume”, “mute”, “SC” or “BS” is imprinted on the face of an operation button.

When the user looks at the above types of operation buttons, the user can intuitively understand how the electronic device behaves after pressing the buttons.

However, a remote controller may comprise a plurality of operation buttons which have the same shape and different colors. In some cases, the user cannot intuitively understand how the electronic device behaves after these types of operation buttons (which may be referred to as ambiguous operation buttons, unclear operation buttons or indefinite operation buttons) are pressed. Moreover, because these operation buttons are unclear, the user may not notice the existence of functions related to the indefinite operation buttons in the electronic device.

In consideration of the above factors, an embodiment aims to provide an electronic apparatus, a server or an electronic apparatus control system which allows the user to easily understand in advance the functions (or the behaviors of the electronic apparatus) realized when the operation buttons (which may be referred to as operation keys) of the remote controller are pressed.

Another embodiment aims to provide an electronic apparatus, a server or an electronic apparatus control system configured to output, at an appropriate timing, a message which allows the user to easily understand in advance the functions realized when the operation buttons of the remote controller are pressed.

In general, according to an electronic apparatus of an embodiment, a button data notification unit transmits a button data table of a plurality of operation buttons for operating the electronic apparatus to a server. An operation button notification unit transmits, in response to an operation of an arbitrary operation button, a control command corresponding to the operated operation button to the server. An instruction command receiver receives, from the server, an instruction command specifying an operation button to be displayed and an operation guide of the operation button in accordance with the control command. The server prepares an instruction command related to each of the plurality of operation buttons corresponding to the button data table and an operation guide of each of the plurality of operation buttons. An operation guide output unit outputs, to a display device, the operation button and the operation guide to be displayed in accordance with the instruction command received by the instruction command receiver.

The server of the embodiment mainly comprises a receiver and a transmitter. The receiver receives, from a television receiver (client device), a button data table of a plurality of operation buttons for operating the television receiver. A memory is used for storing an instruction command related to an operation button and an operation guide to be displayed in the television receiver based on a control command corresponding to an arbitrary operation button operated in the television receiver. A transmitter sends back the instruction command as response data to the television receiver.

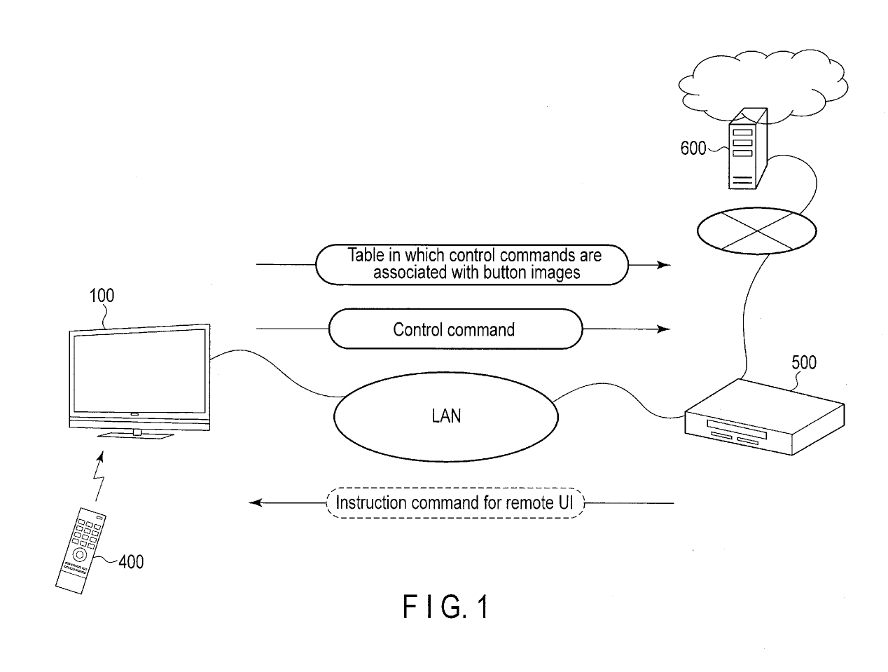

Embodiments will be described hereinafter with reference to the accompanying drawings. FIG. 1 shows a typical example of a structure of an electronic apparatus control system to which an embodiment is applied.

The reference number 100 shows, for example, a television receiver. The television receiver 100 may be referred to as a client device. The television receiver 100 is operated by a remote controller 400. The remote controller 400 is configured to conduct operations relative to the television receiver 100, such as power on or off, initial setting, channel selection, sound volume adjustment and image quality adjustment.

The television receiver 100 is connected to, for example, an in-home local area network (LAN). A server 500 is also connected to the LAN. A system which provides a remote user interface (UI) via the LAN is established between the television receiver 100 and the server 500.

In the remote UI system, the server 500 generates the images of a remote UI and transmits the images and positional data specifying the display position of each image to the television receiver 100. The television receiver 100 performs a rendering process based on the received images and positional data and displays the remote UI. When the television receiver 100 receives an operation signal from the remote controller 400, the television receiver 100 transmits the control command corresponding to the operation signal to the server 500. The server 500 sends back an instruction command for the remote UI to the television receiver 100 based on the received control command.

Now the following situations are imaged, for example, the television receiver 100 receives a remote UI containing a cursor image and displays the cursor on the screen. If the user presses the operation button for cursor operation in the remote controller 400 to move the cursor, the television receiver 100 transmits the control command corresponding to the operation button to the server 500. The server 500 interprets the received control command and sends back an instruction command for executing the move of the cursor (in other words, an instruction command for specifying the display position of the cursor image) to the television receiver 100. The television receiver 100 changes the display position of the cursor on the screen based on the instruction command.

If the user presses the operation button for program list display in the remote controller 400, the television receiver 100 transmits the control command corresponding to the operation button for program list display to the server 500. The server 500 interprets the received control command, transmits the remote UI of the program list to the television receiver 100 and transmits an instruction command for executing the display of the remote UI of the program list to the television receiver 100. The television receiver 100 operates to display the program list on the screen based on the instruction command.

To realize the above-described remote controller UI system, the television receiver 100 transmits the images (or identification data of the images) of the operation buttons provided in the remote controller 400 for operation, and button data in which the button images are associated with control commands at the time of initial setting or power on.

The server 500 is configured to recognize the identification data sent from the television receiver 100 and recognize the display capability of the television receiver 100. The display capability refers to, for example, the screen size and the resolution of the television receiver 100. The server 500 is configured to control the display operation of the UI image of the television receiver 100 based on the display capability of the television receiver 100.

An external server 600 is connected to the server 500 via an external network such as the Internet. In the embodiment below, the television receiver 100 performs various processes with the server 500. However, the television receiver 100 may perform similar processes with the external server 600. The external server 600 may have the functions similar to those of the server 500.

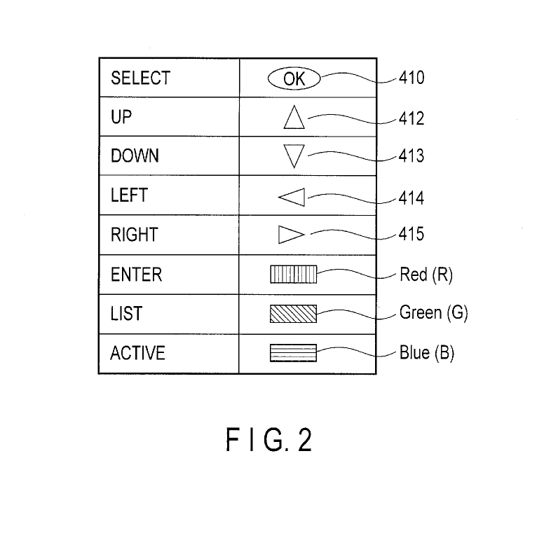

FIG. 2 shows a button data table indicating the relationships between control commands and button images.

In the table:

The image 410 of the button “OK” of the remote controller is associated with the control command “SELECT”;

The image 412 of the upward triangular button of the remote controller is associated with the control command “UP”;

The image 413 of the downward triangular button of the remote controller is associated with the control command “DOWN”;

The image 414 of the leftward triangular button of the remote controller is associated with the control command “LEFT”;

The image 415 of the rightward triangular button of the remote controller is associated with the control command “RIGHT”;

The image R of the red rectangular button of the remote controller is associated with the control command “ENTER”;

The image G of the green rectangular button of the remote controller is associated with the control command “LIST”; and

The image B of the blue rectangular button of the remote controller is associated with the control command “ACTIVE”.

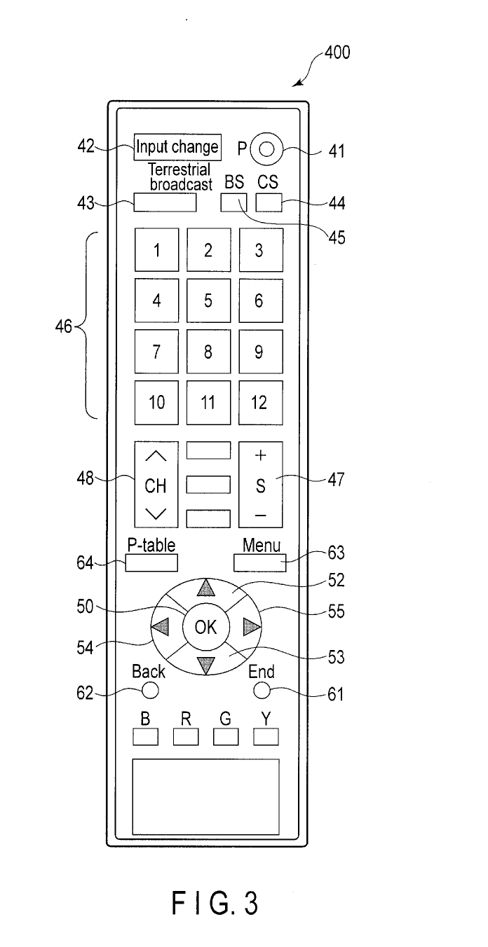

FIG. 3 shows an example of the remote controller. The remote controller 400 comprises button 41 for power on and off, button 42 for in-line switching, button 43 for selection of terrestrial broadcast, button 44 for selection of CS broadcast and button 45 for selection of BS.

The remote controller 400 further comprises a group of buttons 46 on which the numbers “1” to “12” are imprinted, button 47 for sound volume adjustment, button 48 for reception channel change and the like. Button 50 is an OK button. Buttons 52 and 53 indicate directions as explained in FIG. 2. Button 62 is a back button and an operation button for returning the menu screen of the television receiver to the previous screen state. Button 61 is an end button.

Button 63, above which the legend “Menu” is imprinted, is an operation button for changing the screen state to the menu screen. Button 64, above which the legend “P-table” is imprinted, is an operation button for displaying the program list.

When operation guides which indicate button functions are imprinted around buttons as stated above, the user can easily select a button based on the need. However, the remote controller 400 comprises a plurality of buttons (indefinite or unclear buttons B, R, G and Y) which have the same shape and different colors. Since no operation guide is shown for these buttons, the user cannot understand how the television receiver behaves in response to the operations relative to the buttons when the user looks at the buttons. The user cannot be confident in operating the indefinite buttons.

In the present embodiment, it is possible to appropriately provide the user with the operation guides of the indefinite buttons on the screen. In the present embodiment, the user can confidently operate buttons B, R, G and Y.

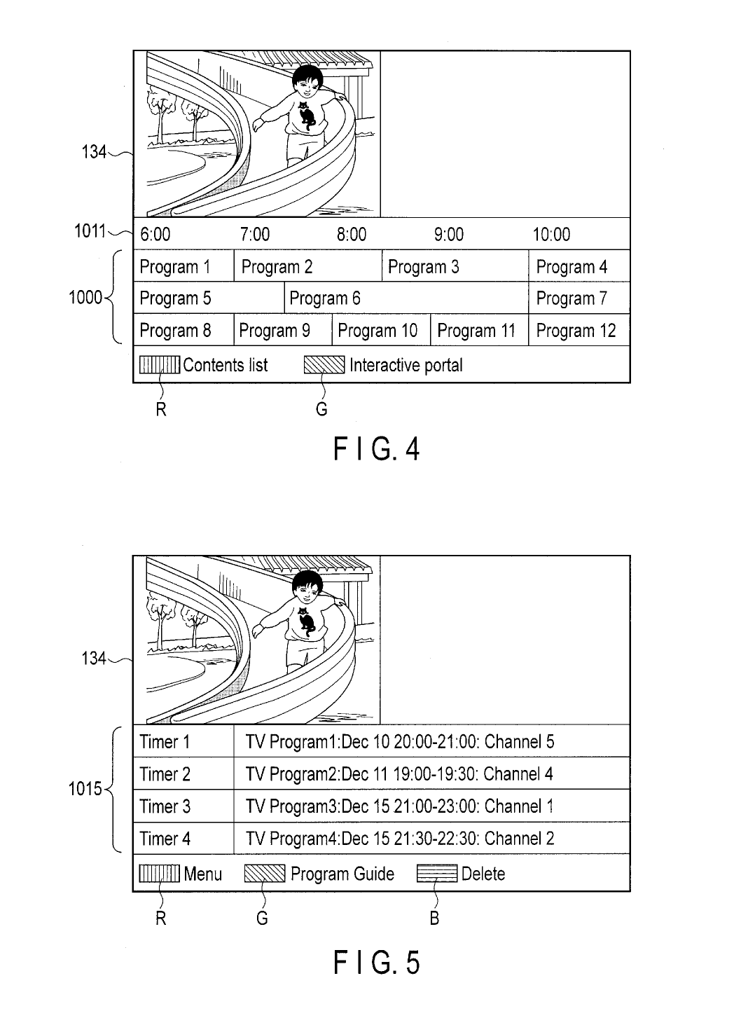

Now, this specification explains examples of screen structures of remote UIs with reference to FIG. 4 to FIG. 6. The server 500 generates the images constituting each of the remote UIs and transmits the images and data indicating the layout position of each image to the television receiver 100. The server 500 also generates the images indicating the association between commands which can be used in the remote UI and buttons of the remote controller (in other words, the images of operation buttons and operation guides) based on the button data table explained in FIG. 2. The server 500 transmits the remote UI containing these images to the television receiver 100.

The server 500 may transmit the images of the remote UI to the television receiver 100 at the time of reception of a request of the remote UI. The server 500 may transmit the images to the television receiver 100 before the request. When the images of the remote UI are transmitted in advance, the television receiver 100 stores the images. If the television receiver 100 receives a display instruction from the server 500, the television receiver 100 displays the images based on the instruction.

FIG. 4 shows a screen which is displayed when, for example, the user operates a button for displaying a program list 1000. The program list 1000 is displayed when, for example, the user selects the item “program list” from the menu displayed on the screen and presses the button “OK”, or when the user presses the operation button having the description “program list” in the remote controller.

The program list 1000 contains a time display area 1011 and a program name display area 1012. In the example shown in the figure, the program names are simplified as “program 1” to “program 12”. However, in practice, the specific program names and cast members are described. The days such as Monday, Tuesday, Wednesday, . . . , Sunday are displayed in the left part of the program list although they are not seen in the figure. To see the days, the user scrolls the program list by using the scrolling button of the remote controller.

For example, operation buttons and operation guides are displayed as images in the lower area 1013 of the screen. In this example, the operation guide “Content list” is displayed in association with the red button R. This means that the display of the content list can be obtained when the red button R is pressed. For example, when the user operates the remote controller, specifies the desired time by the cursor and presses the red button R of the remote controller, the list of programs in the specified time is displayed.

The operation guide “Interactive portal” is displayed in association with the green button G. This means that, for example, the change to the intercommunication state with another device can be realized when the green button G is pressed. Another device refers to, for example, another television receiver or recording/reproducing device connected via the in-home local area network (LAN).

In this manner, the user can easily understand which indefinite operation button can be operable in the state where the program list is displayed and what kind of operation result can be obtained (in other words, how the electronic apparatus behaves) when the button is operated.

FIG. 5 shows an example in which a recording reservation list 1015 is displayed on the screen of the television receiver 100. The recording reservation list 1015 is displayed when, for example, the user selects the item “recording reservation list” from the menu displayed on the screen and presses the button “OK”.

FIG. 5 illustrates the recording reservation list 1015 in which timers 1 to 4 are shown. Timers 1 to 4 contain TV programs 1 to 4, respectively, and the date, time and channel of each program to be recorded. This example is simplified. In practice, the specific program names and cast members are described for TV programs 1 to 4. In the area below the recording reservation list 1015, the images of the red button R, the green button G and the blue button B are displayed. The legend “menu” is displayed beside the red button R. The legend “program guide” is displayed beside the green button G. The legend “delete” is displayed beside the blue button B.

When the red button R is pressed while the recording reservation list 1015 shown in FIG. 5 is displayed, the television receiver moves to the menu display state. When the green button G is pressed while the recording reservation list 1015 is displayed, the television receiver moves to the program guide state (shown in FIG. 4). When the blue button B is pressed while the recording reservation list 1015 is displayed, deletion is effected.

When the blue button B is used, the user moves the cursor onto the reserved program to be deleted in advance by operating the remote controller. When the user presses the blue button B in this state, the reservation of the selected program is cancelled.

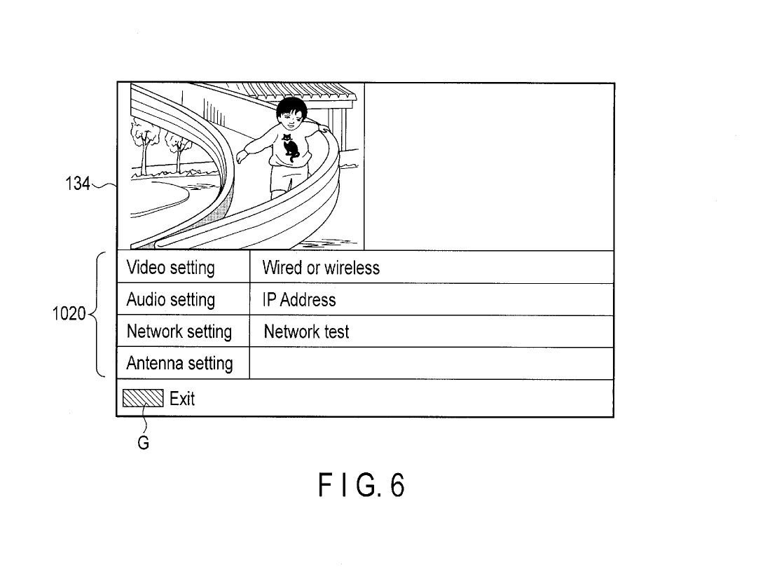

FIG. 6 shows an example in which an item 1020 for various settings is displayed on the screen of the television receiver 100. The television receiver 100 moves to this display state when, for example, the user selects the item “setting” from the menu and presses the button “OK”.

The item 1020 includes, for example, setting items “video setting”, “audio setting”, “network setting” and “antenna setting”. These setting items are only part of the whole item 1020. More setting items are displayed by a scrolling operation. When the setting item “video setting” is selected and confirmed, for example, the television receiver 100 is configured to move to the setting screen for determining whether video is received by a wired or wireless method. When the setting item “audio setting” is selected and confirmed, the television receiver 100 is configured to move to the setting screen for determining the IP address for audio transmission and reception. When the setting item “network setting” is selected and confirmed, the television receiver 100 is configured to move to the screen for testing the network.

The green button G is displayed on the screen. The legend “exit” is displayed beside the green button G. When the green button G is pressed, the whole screen returns to the program display state.

As described above, the present embodiment can appropriately provide the user with the operation guides of indefinite buttons on the screen. Therefore, the user can effectively use buttons B, R, G and Y, etc.

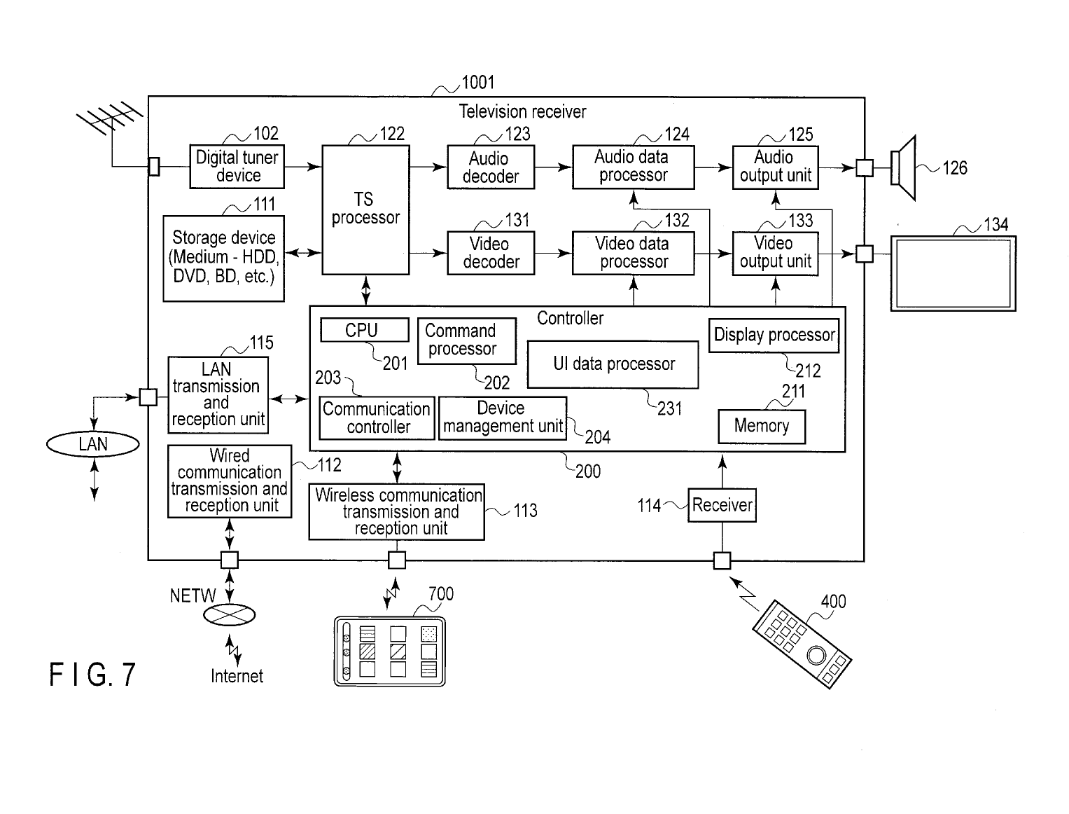

FIG. 7 shows a typical example of a configuration of the television receiver 100 to which an embodiment is applied. In the present embodiment, an example of the configuration of the television receiver 100 is shown. The configuration of the television receiver 100 is not limited to this example.

The television receiver 100 comprises a tuner device 102. The tuner device 102 includes a plurality of tuners configured to receive, for example, a scrambled digital terrestrial broadcast signal. The tuner device 102 may include a tuner (not shown) for digital broadcasting satellite (BS)/communication satellite (CS) broadcast reception.

The broadcast program signal received by the tuner device 102 is input to a TS processor 122. The transport streams (TS) of a plurality of channels (CH) are multiplexed again into a TS and become a multiplexed TS. In the multiplexed TS, a series of packets of broadcast programs of channels is multiplexed. Identification data for identifying the channel and packet is added to the packet of each channel.

The multiplexed TS is input to a recording/reproducing device 111. A packet containing control data in the TS input to the TS processor 122 is input to a controller 200 to be processed.

The recording/reproducing device 111 comprises, for example, a hard disk drive and/or an optical disk recording/reproducing device. For an optical disk, for example, a Digital Versatile Disk (DVD) and/or a Blu-ray Disc (BD) (registered trademark) are/is employed. The recording/reproducing device 111 is configured to record and reproduce a multiplexed TS.

The packet transmitted from the TS processor 122 to the controller 200 contains, for example, an entitlement control message (ECM) which is encrypted data of a broadcast program, data of event information table (EIT) in which event information such as the program name, casting members and staring time is described, and data of an electronic program guide (EPG).

The video data included in a packet is encoded by, for example, the Moving Picture Expert Group (MPEG) system or the Advanced Video Coding (AVC) system. The audio data in an audio packet is encoded by, for example, the Pulse Code Modulation (PCM) system, the Dolby (registered trademark) system or the MPEG system. The TS processor 122 separates the packet of a program into a video packet and an audio packet.

The packet containing audio data in the packet separated by the TS processor 122 is input to an audio decoder 123 and is subjected to the decoding process corresponding to the encoding system. An audio data processor 124 applies a synchronous process and sound volume adjustment to the audio data decoded by the audio decoder 123. The audio data is supplied to an audio output unit 125. The audio output unit 125 applies a stereo separation process to the data in accordance with the speaker system and supplies the output to a speaker 126.

The packet containing video data in the packet separated by the TS processor 122 is input to a video decoder 131 and is subjected to the decoding process corresponding to the encoding system. A video data processor 132 applies a synchronous process, luminance adjustment and color adjustment to the video data decoded by the video decoder 131. The output of the video data processor 132 is supplied to a video output unit 133. The video output unit 133 is configured to multiplex the data, the figure and the program list from the controller 200 on the main video signal. The video output unit 133 sets the scale, the resolution, the number of lines and the aspect ratio in accordance with a display device 134 relative to the output video signal and outputs the signal to the display device 134.

The audio packets and video packets of some paid programs are encrypted. In these cases, the encrypted packets are decoded by using key data. The system of this process is omitted here.

The controller 200 comprises a central processing unit (CPU) 201, an operation command processor 202, a communication controller 203, an operation device management unit 204, a display processor 211 and a memory 212. Although the controller 200 further comprises an electronic program guide (EPG) data processor, a recording controller and the like, these elements are omitted in the figure.

The CPU 201 controls the whole operation sequence of the controller 200. The operation command processor 202 is configured to analyze an operation command input from outside and reflect the operation corresponding to the command on the television receiver 100.

The operation device management unit 204 is configured to recognize and manage the device identification data of a mobile device 700 and the remote controller 400 which provide the controller 200 with an operation signal.

The display processor 211 is configured to control the video signal displayed on the display device 134 via the video output unit 133 as a whole. The display processor 211 is also configured to adjust the resolution, the display size and the display area of the image signal. The display processor 211 is further configured to supply, to the video output unit 133, the video signal of the program list prepared by using EPG data and the menu video signal prepared in the controller 200 in accordance with the operation signal. Various types of data and applications stored in the controller 200 can be stored in the memory 212.

The communication controller 203 is connected to a wired communication transmission and reception unit 112, a wireless communication transmission and reception unit 113, a receiver 114 and a LAN transmission and reception unit 115.

The communication controller 203 is configured to transmit data and content from the television receiver 100 to outside. The communication controller 203 is also configured to transmit the aforementioned button data and a control command to the server 500.

The communication controller 203 is configured to receive content data, control data and an instruction command for a remote UI from outside via the wired communication transmission and reception unit 112, the wireless communication transmission and reception unit 113, the receiver 114 and the LAN transmission and reception unit 115.

The received content, data and command can be stored in, for example, the recording/reproducing device 111 or the memory 212.

The wireless communication transmission and reception unit 113 is configured to conduct data transmission and reception with a plurality of mobile devices 700 and is used for close-range communication. Each mobile device 700 is configured to remotely control the television receiver 100. The mobile device 700 is configured to access the server via a base station (not shown) and the Internet. The mobile device 700 is configured to download content, various applications and game software from the server and transmit them to the controller 200 via the wireless communication transmission and reception unit 113. The mobile device 700 is configured to transmit data for obtaining content (for example, the address of a Web server, an e-mail address and a network address) to the controller 200 via the wireless communication transmission and reception unit 113.

When content, an application or game software is transmitted from the mobile device 700, the communication controller 203 operates. The communication controller 203 stores the received content in the memory 212. The content may be stored in the recording/reproducing device 111 based on the operation command, or may be automatically stored in the recording/reproducing device 111. The recording/reproducing device 111 is configured to record the received content in, for example, a hard disk. In the hard disk, the content is managed as a content file.

The communication controller 203 is configured to receive an operation signal from the remote controller 400 via the receiver 114.

The wired communication transmission and reception unit 112 is configured to conduct data transmission and reception with a remote server via the Internet.

The menu video signal and the program list video signal for display are stored in or managed by the display processor 211. When the menu or the program list is displayed, the menu screen data or the program list video signal is read from a data storage unit (the memory or the hard disk) and a UI data processor 231 based on the control of the display processor 212 and is supplied to the video output unit 133. In this manner, the menu image or the program list image is displayed in the display device 134.

The menu video signal and the program list video signal for display may be transmitted to the mobile device 700. When the mobile device 700 requests the menu video signal or the program list video signal, the communication controller 203 is configured to transmit the menu video signal or the program list video signal to the mobile device 700.

The mobile device 700 is configured to display the menu video signal and the program list video signal on the screen of a touchpanel. The user can provide the television apparatus with an operation instruction by touching an operation button displayed on the screen of the touchpanel (or a pointing type of panel).

The LAN transmission and reception unit 115 is connected to the in-home LAN.

The controller 200 comprises the characteristic UI data processor 231. The UI data processor 231 is closely connected with the matters explained in FIG. 2 to FIG. 6.

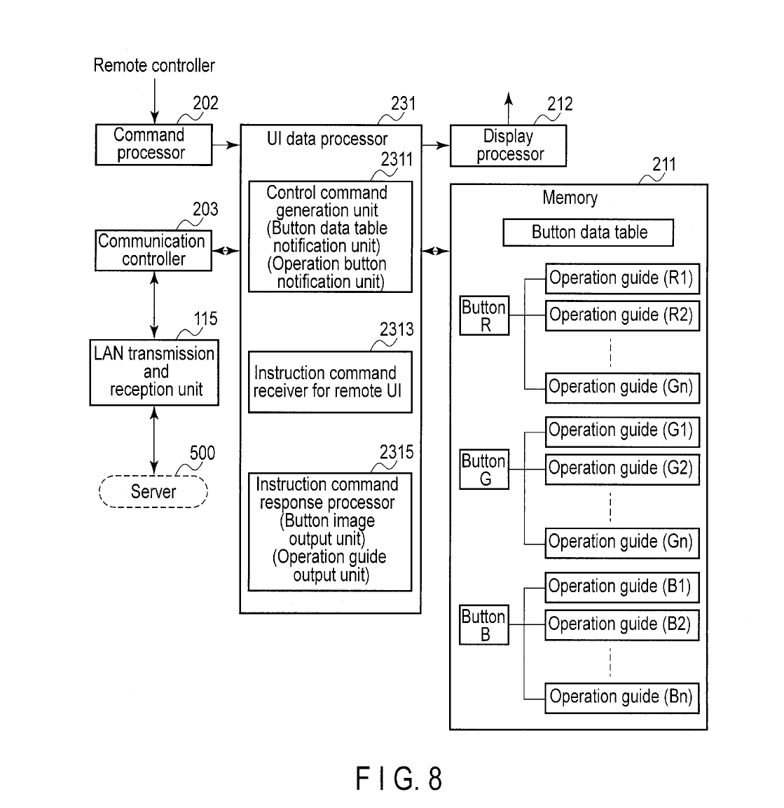

In FIG. 8, the main blocks which operate in connection with the UI data processor 231 are extracted. However, the configuration of the UI data processor 231 and its related blocks are not limited to the example shown in FIG. 8. For example, the block of the UI data processor 231 in the controller 200 may be realized by software.

The UI data processor 231 comprises a control command generation unit 2311, an instruction command receiver 2313 for a remote UI, an instruction command response processor 2315 and the like. The control command generation unit 2311 comprises a button data notification unit for notifying the server of the button data table, and an operation button notification unit for notifying the server of the operated operation button. The button data notification unit may be referred to as a button data table notification unit.

The instruction command response processor 2315 comprises a button image output unit for selecting a button image from the memory and outputting the image to the display unit, and an operation guide output unit for selecting the operation guide corresponding to the button from the memory and outputting the guide to the display device.

The operation signal input from the remote controller is interpreted in the command processor 202 and is processed in the UI data processor 231. The UI data processor 231 is configured to output the related data (the button data table and the control command) corresponding to the operation signal to the server 500. The related data is transmitted to the server 500 via the communication controller 203 and the LAN transmission and reception unit 115.

For example, in connection with the input of the operation signal for turning the television receiver on, the UI data processor 231 reads the button data table (shown in FIG. 2) from the memory 211 and transmits the table to the server 500. The identification data of the television receiver and the remote controller is also transmitted to the server.

In this manner, the server 500 can recognize the functions of the operation buttons contained in the button data table and set operation guides relative to the recognized functions.

The association data related to the functions of operation buttons of the remote controller and the operation guide corresponding to each function may be stored in advance in the server 500.

In a first example, the functions of operation buttons of the remote controller and the operation guide corresponding to each function may be stored in advance in the server 500. The identification data of functions of operation buttons of the remote controller and the operation guide corresponding to each function may be stored in advance in the server 500. In this case, an operation button and the operation guide corresponding to the operation button are selected from the memory 211 based on the identification data.

When the display of the program list is requested by operation of the remote controller, the control command generation unit 2311 generates a control command which indicates that the display of the program list is requested. The control command is transmitted to the server 500.

The server 500 transmits the remote UI of the program list shown in FIG. 4 to the television receiver 100 in response to the control command and instructs the television receiver 100 to display the remote UI. The remote UI contains buttons R and G and the operation guides of these buttons. When the remote UI of the program list is transmitted in advance, the server 500 transmits, to the television receiver 100, an instruction command for displaying the program list, an instruction command for displaying buttons R and G and an instruction command for displaying the operation guide relative to each button. When the program list consists of a plurality of images, the server 500 transmits the display instruction of each of the images.

The UI data processor 231 of the television receiver 100 stores the image of the remote UI transmitted from the server 500 in the memory 211. The UI data processor 231 receives the instruction commands from the server 500 and analyzes the commands in the instruction command receiver 2313 for a remote UI. The instruction command response processor 2315 operates in accordance with the analysis results of the instruction commands.

In this manner, for example, the UI data processor 231 reads the program list data from the memory 211 in response to the instruction command for displaying the program list, supplies the program list data to the display processor 212 and realizes the display of the program list. The UI data processor 231 reads the data related to buttons R and G from the memory 211 in response to the instruction command for displaying buttons R and G and the instruction command for displaying the operation guide relative to each of the buttons. The UI data processor 231 displays buttons R and G and the operation guide relative to each of the buttons as explained in FIG. 4.

A control command which indicates the display of the recording reservation list is requested is generated by operation of the remote controller. The control command is transmitted to the server 500.

The server 500 transmits the remote UI of the recording reservation list shown in FIG. 5 to the television receiver 100 and instructs the television receiver 100 to display the remote UI. The remote UI contains buttons R, G and B and the operation guides of these buttons. When the remote UI of the recording reservation list is transmitted in advance, the server 500 transmits, to the television receiver 100, an instruction command for displaying the recording reservation list and an instruction command for displaying buttons R, G and B and the operation guides of these buttons.

The UI data processor 231 of the television receiver 100 stores the image of the remote UI transmitted from the server 500 in the memory 211. The UI data processor 231 receives the instruction commands from the server 500 in the instruction command receiver 2313 for a remote UI and analyzes the commands. The instruction response processor 2315 operates in accordance with the analysis content of the instruction commands.

The instruction command response processor 2315 reads the data of the recording reservation list from, for example, the memory 211, supplies the data to the display processor 212 and realizes the display of the recording reservation list.

In response to the instruction command for displaying buttons R, G and B and the operation guides corresponding to the buttons, the UI data processor 231 reads the data related to buttons R, G and B from the memory 211 and displays buttons R, G and B and the operation guides corresponding to the buttons as explained in FIG. 5.

When the display of the item for various settings is requested by operation of the remote controller, the control command generation unit 2311 generates a control command which indicates that the display of the item for various settings is requested. The control command is transmitted to the server 500.

In response to the control command, the server 500 transmits the remote UI of the item 200 for various settings shown in FIG. 6 to the television receiver 100 and instructs the television receiver 100 to display the remote UI. The remote UI contains button G and the operation guide of the button. When the remote UI of the item 200 for various settings is transmitted in advance, the server 500 transmits, to the television receiver 100, an instruction command for displaying the item 200 for various settings, an instruction command for displaying button G and an instruction command for displaying the operation guide relative to button G.

As described above, in the present embodiment, the operation guide of an indefinite operation button or an ambiguous operation button can be displayed based on various operation situations of the television receiver. The display of the operation guide is based on an instruction from the server.

In the present embodiment, a plurality of types of operation guides are prepared in the memory 211 relative to one button because, for example, the operation guide related to button G differs depending on the situation as explained in FIG. 4, FIG. 5 and FIG. 6. The operation guide related to button R also differs depending on the situation.

In the above embodiment, a plurality of types of operation guides are stored in advance in the memory 211 relative to a button. However, in another embodiment, when the server 500 recognizes the television receiver 100 and its remote controller 400, the server 500 may transmit the data of a plurality of operation guides relative to a button to the television receiver 100, and the data may be stored in the memory 211.

In other words, the server 500 is configured to generate a remote UI (containing the image of a button and the image of the operation guide of the button) based on the button data transmitted from the television receiver 100 and transmit the remote UI to the television receiver 100 in advance or depending on the need. The television receiver 100 is configured to store the remote UI in the memory 211 as the data of a plurality of operation guides relative to a button.

After the data of a plurality of operation guides relative to a button is stored in the memory 211, the server 500 is configured to transmit an instruction command containing the specified data for specifying an operation guide corresponding to the button depending on the situation of each operation. In response to the instruction command, the television receiver 100 displays the specified button and operation guide.

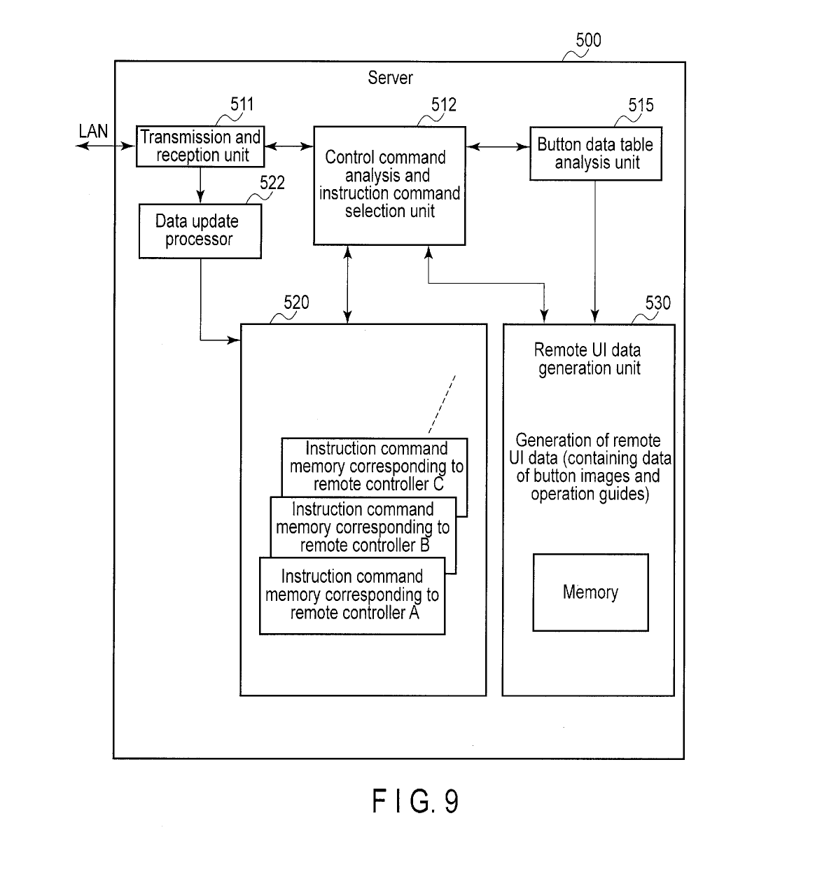

FIG. 9 shows an example of a configuration of the server 500 according to the present embodiment. The server 500 comprises a transmission and reception unit 511 and is connected to a LAN in order to communicate with the television receiver 100. The server is not necessarily connected to a LAN and may be connected to the Internet.

The server 500 comprises a control command analysis and instruction command selection unit 512, a button data table analysis unit 515, a memory 520 and a data update processor 522. The server 500 further comprises a remote UI data generation unit 530.

When the communication with the television receiver 100 is started, and a button data table is transmitted from the television receiver 100, the remote UI data generation unit 530 generates the images corresponding to the buttons described in the button data and the operation guides of the buttons. In short, the remote UI data generation unit 530 generates the remote UI data for the television receiver 100. The remote UI data is transmitted to the television receiver 100 in advance via the control command analysis and instruction command selection unit 512. The remote UI data may be stored in the memory, and the image data of an appropriate UI may be transmitted to the television receiver 100 depending on the need when a control command is transmitted from the television receiver 100. The type of UI image data to be selected and sent back to the television receiver 100 is determined based on the data transmitted from the television receiver 100 and the program installed in the server.

In the above explanation, the remote UI data is generated by the remote UI data generation unit 530 when button data is transmitted from the television receiver 100. However, remote UI data for various television receivers may be stored in the memory in advance. The data update processor 522 may update the remote UI data for a new television receiver or an updated television receiver.

Instruction commands corresponding to control commands generated based on operation signals of the remote controller are stored as an instruction command table in the memory 520. In addition to the instruction command table for a remote controller, instruction command tables for other various remote controllers are stored.

The instruction command table to be adopted is determined based on the analysis result obtained by the command data table analysis unit 515 which analyzes the command data transmitted from the television receiver when the communication with the television receiver is started.

For example, a control command for requesting the display of the program list is obtained from the analysis result. In this case, the server 500 transmits, to the television receiver 100, an instruction command for displaying the program list, an instruction command for displaying buttons R and G and an instruction command for displaying the operation guide relative to each of the buttons.

The memory 520 and the remote UI data generation unit 530 may be integrally structured. Naturally, the data processing block in the server 500 may be structured by software.

In the present embodiment, the server 500 basically and mainly comprises a receiver and a transmitter. The receiver receives, from a television receiver (client device), the button data table of a plurality of operation buttons for operating the television receiver. The transmitter sends back, to the television receiver, an instruction command related to the operation button to be displayed in the television receiver and the operation guide to be displayed in the television receiver as response data based on the control command corresponding to the arbitrary operation button operated in the television receiver.

In the above explanation, the term “unit” may be replaced by the term “apparatus”, “device”, “block” or “module” in each block. Even if the replacement by these terms is applied, the elements are naturally within the scope of the present invention. Moreover, even if a structural element is separated, or a plurality of elements are combined, or a separated element and a combined element are shown in combination in the expression of claims, all of the elements are within the scope of the present invention. Even if a claim is directed to a method, a control logic, a program including an instruction for executing a computer or a computer-readable recording medium in which the instruction is described, the device of the present invention is applied in the claim.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a button data notification unit configured to transmit a button data table of a plurality of operation buttons for operating the electronic apparatus to a server;
an operation button notification unit configured to, in response to an operation of an arbitrary operation button, transmit a control command corresponding to the operated operation button to the server;
an instruction command receiver configured to receive, from the server, an instruction command which specifies an operation button to be displayed and an operation guide of the operation button in accordance with the control command, the server preparing an instruction command related to each of the plurality of operation buttons and an operation guide of each of the plurality of operation buttons; and
an operation guide output unit configured to output the operation button to be displayed and the operation guide to be displayed to a display device in accordance with the instruction command received by the instruction command receiver.

2. The electronic apparatus of claim 1, wherein
regarding the operation button to be displayed and the operation guide to be displayed, a plurality of operation guides are prepared relative to one operation button, and one of the plurality of operation guides is specified based on an operation situation of the arbitrary operation button.

3. The electronic apparatus of claim 1, wherein
regarding the operation button to be displayed, a plurality of operation buttons are prepared, the plurality of operation buttons including a plurality of operation buttons which have a same shape and different colors.

4. The electronic apparatus of claim 1, wherein
data of the operation button to be displayed and the operation guide to be displayed is sent from the server and is stored in a memory.

5. The electronic apparatus of claim 1, wherein
the button data notification unit is configured to transmit button data of the plurality of operation buttons to the server when the electronic apparatus is switched on.

6. The electronic apparatus of claim 1, wherein
the operation guide output unit is configured to output the operation button to be displayed and the operation guide to be displayed to the display device in a state where a program list is displayed in the display device.

7. The electronic apparatus of claim 1, wherein
the operation guide output unit is configured to output the operation button to be displayed and the operation guide to be displayed to the display device in a state where a recording reservation list is displayed in the display device.

8. The electronic apparatus of claim 1, wherein
the operation guide output unit is configured to output the operation button to be displayed and the operation guide to be displayed to the display device in a state where a setting item is displayed in the display device.

9. The electronic apparatus of claim 1, wherein
the server comprises:
a receiver configured to receive, from a client device, data related to association between a plurality of operation buttons for operating the client device and operation commands; and
a transmitter configured to transmit, to the client device, a user interface containing an image indicating at least one of the plurality of operation buttons and an operation command corresponding to the operation button.

10. The electronic apparatus of claim 9, further comprising
a memory in which an instruction command for instructing the user interface is stored, the user interface being formed by the operation button and the operation guide to be displayed in the client device, wherein
the transmitter is configured to send back the instruction command as response data to the client device when a control command is sent from the client device based on an arbitrary operation button.

11. The electronic apparatus of claim 10, wherein a plurality of instruction commands for a plurality of remote controllers are prepared in the memory.

12. An electronic apparatus control system comprising a client device comprising:
a button data notification unit configured to transmit, to a server, button data of a plurality of operation buttons for operating the client device;
an operation button notification unit configured to transmit, in response to an operation of an arbitrary operation button, a control command corresponding to the operated operation button to the server;
an instruction command receiver configured to receive, form the server, an instruction command for instructing an operation button to be displayed and an operation guide of the operation button in accordance with the control command; and
an operation guide output unit configured to output, to a display device, a user interface formed by the operation button and the operation guide to be displayed in accordance with the instruction command received by the instruction command receiver, wherein
the server comprises:
a receiver configured to receive the button data;
a memory in which an instruction command for instructing the user interface is stored; and
the transmitter configured to send back the instruction command as response data to the client device when the control command is sent from the client device based on an arbitrary operation button.
